(19) United States
(12) Patent Application Publication
(10) Pub. No.: US 2004/0242421 A1
(43) Pub. Date: Dec. 2, 2004

(54) Herbicidal composition

(76) Inventor: Derek Cornes, Basel (CH)

Correspondence Address: SYNGENTA BIOTECHNOLOGY, INC., PATENT DEPARTMENT, 3054 CORNWALLIS ROAD, P.O. BOX 12257, RESEARCH TRIANGLE PARK, NC, 27709-2257, US

(21) Appl. No.: 10/490,141

(22) PCT Filed: Sep. 19, 2002
(86) PCT No.: PCT/EP02/10540

(30) Foreign Application Priority Data
Sep. 20, 2001 (CH) 1738/01

(51) Int. Cl. A01N 43/40; A01N 43/80

(52) U.S. Cl. 504/130; 504/271

(57) ABSTRACT

A herbicidal composition which, in addition to comprising customary inert formulation adjuvants, comprises

a) metolachlor and/or the S enantiomer thereof and

b) a synergistically effective amount of amicarbazone, foramsulfuron, tritosulfuron or the compound of formula A

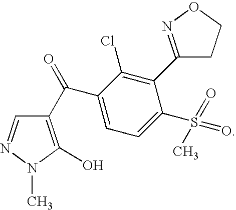

The present invention relates to a novel herbicidal synergistic composition comprising a herbicidal active ingredient combination that is suitable for the selective control of weeds in crops of useful plants, for example in crops of maize.

The invention relates also to a method of controlling weeds in crops of useful plants, and to the use of the novel composition for that purpose.

Metolachlor and its S enantiomer have herbicidal activity, as described, for example, in The Pesticide Manual, 12th Edition, BCPC, 2000.

Amicarbazone, foramsulfuron, tritosulfuron and the compound of formula A

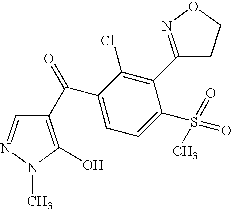

are likewise known as herbicides: amicarbazone is described in, inter alia, The Pesticide Manual, 12th Edition, BCPC, 2000; tritosulfuron is known, for example, from EP-A-559 814, and the compound of formula A is mentioned, for example, in WO 98/31681.

Surprisingly, it has now been found that a combination of variable amounts of at least two active ingredients, that is to say of metolachlor and/or its S enantiomer with at least one of the active ingredients mentioned above, exhibits a synergistic action that is capable of controlling, both pre-emergence and post-emergence, the majority of weeds occurring especially in crops of useful plants without causing any appreciable damage to the useful plant.

There is therefore proposed in accordance with the present invention a novel herbicidal composition for selective weed control which, in addition to comprising customary inert formulation adjuvants, comprises as active ingredient a mixture of

a) metolachlor and/or the S enantiomer thereof and

b) a synergistically effective amount of at least one of the compounds from the group amicarbazone, foramsulfuron, tritosulfuron and the compound of formula

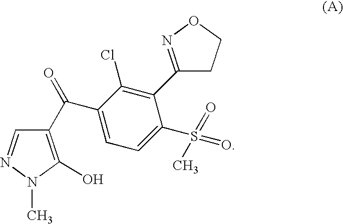

It is extremely surprising that the combination, in accordance with the invention, of the mentioned active ingredients exceeds the additive action on the weeds to be controlled that is to be expected in principle and thus broadens the range of action of the two active ingredients especially in two respects: firstly, the rates of application of the individual compounds are reduced while a good level of action is maintained and, secondly, the composition according to the invention achieves a high level of weed control also in those cases where the individual substances, in the range of low rates of application, have become useless from the agronomic standpoint. The result is a considerable broadening of the spectrum of weeds and an additional increase in selectivity in respect of the crops of useful plants, as is necessary and desirable in the event of an unintentional overdose of active ingredient. The composition according to the invention, while retaining excellent control of weeds in crops of useful plants, also allows greater flexibility in succeeding crops.

The composition according to the invention can be used against a large number of agronomically important weeds, such as Digitaria, Setaria, Sinapis, Solanum, Echinochloa, Sorghum halepense, Rottboellia, Cyperus, Abutilon, Sida, Xanthium, Amaranthus, Chenopodium, Ipomoea, Galium, Viola and Veronica. The composition according to the invention is suitable for all methods of application conventionally used in agriculture, e.g. pre-emergence application, post-emergence application and seed dressing. The composition according to the invention is suitable especially for controlling weeds in maize, and also for non-selective weed control. “Crops of useful plants” are to be understood to include those which have been made tolerant to herbicides or classes of herbicides as a result of conventional methods of breeding or genetic engineering.

The composition according to the invention comprises the active ingredients in any mixing ratio, but usually has an excess of one component over the other. Preferred mixing ratios of the active ingredients (metolachlor and/or S-metolachlor to the mixing partner) are from 5:1 to 1:2, especially from 2.5:1 to 1:1.

Very especially effective compositions comprise the following active ingredient combinations: metolachlor+amicarbazone, metolachlor+foramsulfuron, metolachlor+tritosulfuron and metolachlor+the compound of formula A. Further very suitable compositions comprise, instead of metolachlor, its S-metolachlor enantiomer or a mixture of metolachlor with a relatively high amount of S-metolachlor, the proportion of S-metolachlor in the mixture being from 60 to 95% by weight, especially from 70 to 90% by weight.

The rate of application may vary within wide limits and depends on the nature of the soil, the method of application (pre- or post-emergence; seed dressing; application to the seed furrow; no tillage application etc.), the crop plant, the weed to be controlled, the prevailing climatic conditions, and other factors governed by the method of application, the time of application and the target crop. The active ingredient mixture according to the invention can generally be applied at a rate of from 0.1 to 5 kg of active ingredient mixture per ha.

It has been found, surprisingly, that specific safeners known from U.S. Pat. No. 5,041,157, U.S. Pat. No. 5,541,148, U.S. Pat. No. 5,006,656, EP-A-0 094 349, EP-A-0 551 650, EP-A-0 268 554, EP-A-0 375 061, EP-A-0 174 562, EP-A-492 366, WO 91/7874, WO 94/987, DE-A-196 12 943, WO 96/29870, WO 98/13361, WO 98/39297, WO 98/27049, EP-A-0 716 073, EP-A-0 613 618, U.S. Pat. No. 5,597,776 and EP-A-0 430 004 are suitable for mixing with the herbicidal composition according to the invention. The present invention accordingly relates also to a selectively herbicidal composition for controlling grasses and weeds in crops of useful plants, especially in crops of maize, that comprises a herbicide mixture according to the invention and a safener (counter-agent, antidote) and that protects the useful plants, but not the weeds, against the phytotoxic action of the herbicide, as well as to the use of such a composition in the control of weeds in crops of useful plants.

There is accordingly also proposed in accordance with the invention a selectively herbicidal composition that, in addition to comprising customary inert formulation adjuvants, such as carriers, solvents and wetting agents, comprises as active ingredient a mixture of

a) metolachlor and/or the S enantiomer thereof,

b) a synergistically effective amount of at least one compound from the group amicarbazone, foramsulfuron, tritosulfuron and the compound of formula A

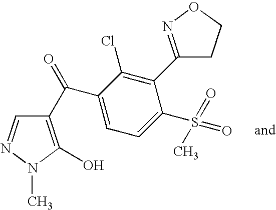

c) an amount, effective for herbicide antagonism, of safener, wherein as safener there is used either a compound of formula S-I

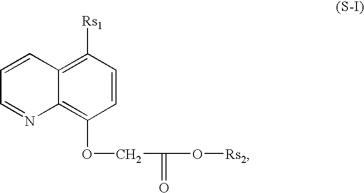

wherein

Rs₁ is hydrogen or chlorine and

Rs₂ is hydrogen, C₁-C₈alkyl, or C₁-C₈alkyl substituted by C₁-C₆alkoxy or by C₃-C₆alkenyloxy;

or a compound of formula S-II

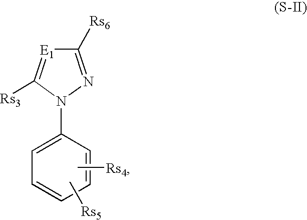

wherein E₁ is nitrogen or methine;

Rs₃ is —CCl₃, phenyl or halo-substituted phenyl;

Rs₄ and Rs₅ are each independently of the other hydrogen or halogen; and

Rs₆ is C₁-C₄alkyl; or a compound of formula S-III

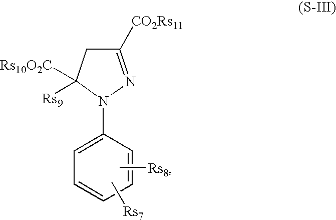

wherein Rs₇ and Rs₈ are each independently of the other hydrogen or halogen and Rs₉, Rs₁₀ and Rs₁₁ are each independently of the others C₁-C₄alkyl; or a compound of formula S-IV

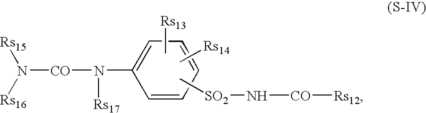

wherein Rs₁₂ is a group

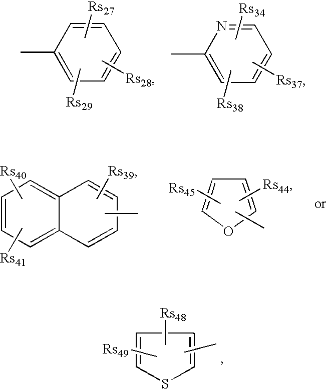

Rs₁₃ is hydrogen, halogen, cyano, trifluoromethyl, nitro, C₁-C₄alkyl, C₁-C₄alkoxy, C₁-C₄alkyl-thio, C₁-C₄alkylsulfinyl, C₁-C₄alkylsulfonyl, —COOH, —COO—C₁-C₄alkyl, —CONRs₁₈Rs₁₉, —C(O)—C₁-C₄alkyl, C(O)-phenyl, or phenyl substituted by halogen, C₁-C₄alkyl, methoxy, nitro or by trifluoromethyl, or is —SO₂NRs₂₀Rs₂₁ or —OSO₂—C₁-C₄alkyl;

Rs₁₈, Rs₁₉, Rs₂₀ and Rs₂₁ are each independently of the others hydrogen or C₁-C₄alkyl, or

Rs₁₈ and Rs₁₉ or Rs₂₀ and Rs₂₁ together form a C₄-C₆alkylene bridge which may be interrupted by oxygen, NH or by —N(C₁-C₄alkyl)-;

Rs₁₄ is hydrogen, halogen, C₁-C₄alkyl, trifluoromethyl, C₁-C₆alkoxy, C₁-C₆alkylthio, —COOH or —COO—C₁-C₄alkyl;

or Rs₁₃ and Rs₁₄ together form a C₃-C₄alkylene bridge which may be substituted by halogen or by C₁-C₄alkyl, or Rs₁₃ and Rs₁₄ together form a C₃-C₄alkenylene bridge which may be substituted by halogen or by C₁-C₄alkyl, or Rs₁₃ and Rs₁₄ together form a C₄alkadienylene bridge which may be substituted by halogen or by C₁-C₄alkyl;

Rs₁₅ and Rs₁₆ are each independently of the other hydrogen, C₁-C₈alkyl, C₃-C₈cycloalkyl,

C₃-C₆alkenyl, C₃-C₆alkynyl,

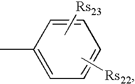

or C₁-C₄alkyl substituted by

C₁-C₄alkoxy or by

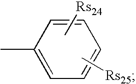

or Rs₁₅ and Rs₁₆ together form a C₄-C₆alkylene bridge which may be interrupted by oxygen, sulfur, SO, SO₂, NH or by —N(C₁-C₄alkyl)-;

Rs₂₂, Rs₂₃, Rs₂₄ and Rs₂₅ are each independently of the others hydrogen, halogen, C₁-C₄alkyl, C₁-C₄alkoxy, C₁-C₄alkylthio, —COORs₂₆, trifluoromethyl, nitro or cyano, Rs₂₆ being, in each case, hydrogen, C₁-C₁₀alkyl, C₁-C₄alkoxy-C₁-C₄alkyl, C₁-C₄alkylthio-C₁-C₄alkyl, di-C₁-C₄alkylamino-C₁-C₄alkyl, halo-C₁-C₈alkyl, C₂-C₈alkenyl, halo-C₂-C₈alkenyl, C₃-C₈alkynyl, C₃-C₇cycloalkyl, halo-C₃-C₇cycloalkyl, C₁-C₈alkylcarbonyl, allylcarbonyl, C₃-C₇cycloalkylcarbonyl, benzoyl which is unsubstituted or substituted on the phenyl ring by up to three identical or different halogen, C₁-C₄alkyl, halo-C₁-C₄alkyl, halo-C₁-C₄alkoxy or C₁-C₄alkoxy substituents; or furyl or thienyl; or C₁-C₄alkyl substituted by phenyl, halophenyl, C₁-C₄alkylphenyl, C₁-C₄alkoxyphenyl, halo-C₁-C₄alkylphenyl, halo-C₁-C₄alkoxyphenyl, C₁-C₆-alkoxycarbonyl, C₁-C₄alkoxy-C₁-C₈alkoxycarbonyl, C₃-C₈alkenyloxycarbonyl, C₃-C₈alkynyl-oxycarbonyl, C₁-C₈alkylthiocarbonyl, C₃-C₈alkenylthiocarbonyl, C₃-C₈alkynylthiocarbonyl, carbamoyl, mono-C₁-C₄alkylaminocarbonyl or by di-C₁-C₄alkylaminocarbonyl; or phenyl-aminocarbonyl which may itself be substituted on the phenyl by up to three identical or different halogen, C₁-C₄alkyl, halo-C₁-C₄alkyl, halo-C₁-C₄alkoxy or C₁-C₄alkoxy substituents or by one cyano or nitro substituent, or dioxolan-2-yl which may itself be substituted by one or two C₁-C₄alkyl groups, or dioxan-2-yl which may itself be substituted by one or two C₁-C₄alkyl groups, or C₁-C₄alkyl which is substituted by cyano, nitro, carboxyl or by C₁-C₈alkylthio-C₁-C₈alkoxycarbonyl;

Rs₁₇ is hydrogen or C₁-C₄alkyl;

Rs₂₇ is hydrogen, halogen, nitro, C₁-C₄alkyl or methoxy;

Rs₂₈ is hydrogen, halogen, C₁-C₄alkyl, trifluoromethyl, C₁-C₆alkoxy, C₁-C₆alkylthio, —COOH or —COO—C₁-C₄alkyl;

Rs₂₉ is hydrogen, halogen, cyano, nitro, C₁-C₄alkyl, C₁-C₄haloalkyl, C₁-C₄alkylthio, C₁-C₄-alkylsulfinyl, C₁-C₄alkylsulfonyl, —COOH, —COO—C₁-C₄alkyl, —CONRs₃₀Rs₃₁, C(O)-phenyl, or phenyl substituted by halogen, C₁-C₄alkyl, methoxy, nitro or by trifluoromethyl, or —SO₂NRs₃₂Rs₃₃, —OSO₂—C₁-C₄alkyl, C₁-C₆alkoxy or C₁-C₆alkoxy substituted by C₁-C₄alkoxy or by halogen, or C₃-C₆alkenyloxy or C₃-C₆alkenyloxy substituted by halogen, or C₃-C₆alkynyloxy; Rs₃₀ and Rs₃₁ each independently of the other being hydrogen or C₁-C₄alkyl, or Rs₃₀ and Rs₃₁ together forming a C₄-C₆alkylene bridge which may be interrupted by oxygen, NH or by —N(C₁-C₄alkyl)- and Rs₃₂ and Rs₃₃ each independently of the other being hydrogen or C₁-C₄alkyl, or Rs₃₂ and Rs₃₃ together forming a C₄-C₆alkylene bridge which may be interrupted by oxygen, NH or by —N(C₁-C₄alkyl)-;

Rs₃₄ is hydrogen, halogen, nitro, C₁-C₄alkyl, C₁-C₄alkoxy, C₁-C₄alkylthio, C₁-C₄alkylsulfinyl, C₁-C₄alkylsulfonyl, —COOH, —COO—C₁-C₄alkyl or CONRs₃₅Rs₃₆, Rs₃₅ and Rs₃₆ each independently of the other being hydrogen or C₁-C₄alkyl, or Rs₃₅ and Rs₃₆ together forming a C₄-C₆alkylene bridge which may be interrupted by oxygen, NH or by —N(C₁-C₄alkyl)-;

Rs₃₇ is hydrogen, halogen, C₁-C₄alkyl, —COOH, —COO—C₁-C₄alkyl, trifluoromethyl or methoxy, or Rs₃₄ and Rs₃₇ together form a C₃-C₄alkylene bridge;

Rs₃₈ is hydrogen, halogen or C₁-C₄alkyl;

Rs₃₉ is hydrogen, halogen, C₁-C₄alkyl, —COOH, —COO—C₁-C₄alkyl, trifluoromethyl or methoxy;

Rs₄₀ is hydrogen, halogen, nitro, C₁-C₄alkyl, C₁-C₄alkoxy, C₁-C₄alkylthio, C₁-C₄alkylsulfinyl, C₁-C₄alkylsulfonyl, —COOH, —COO—C₁-C₄alkyl or CONRs₄₂Rs₄₃;

Rs₄₁ is hydrogen, halogen or C₁-C₄alkyl; or Rs₄₀ and Rs₄₁ together form a C₃-C₄alkylene bridge;

Rs₄₂ and Rs₄₃ are each independently of the other hydrogen or C₁-C₄alkyl, or Rs₄₂ and Rs₄₃ together form a C₄-C₆alkylene bridge which may be interrupted by oxygen, NH or by —N(C₁-C₄alkyl)-;

Rs₄₄ is hydrogen, halogen, C₁-C₄alkyl, —COOH, —COO—C₁-C₄alkyl, trifluoromethyl or methoxy;

Rs₄₅ is hydrogen, halogen, nitro, C₁-C₄alkyl, C₁-C₄alkoxy, C₁-C₄alkylthio, C₁-C₄alkylsulfinyl, C₁-C₄alkylsulfonyl, —COOH, —COO—C₁-C₄alkyl or CONRs₄₆Rs₄₇; Rs₄₆ and Rs₄₇ are each independently of the other hydrogen or C₁-C₄alkyl, or Rs₄₆ and Rs₄₇ together form a C₄-C₆alkylene bridge which may be interrupted by oxygen, NH or by —N(C₁-C₄alkyl)-;

Rs₄₈ is hydrogen, halogen, C₁-C₄alkyl, —COOH, —COO—C₁-C₄alkyl, trifluoromethyl or methoxy;

Rs₄₉ is hydrogen, halogen, nitro, C₁-C₄alkyl, C₁-C₄alkoxy, C₁-C₄alkylthio, C₁-C₄alkylsulfinyl, C₁-C₄alkylsulfonyl, —COOH, —COO—C₁-C₄alkyl or CONRs₅₀Rs₅₁;

Rs₅₁ and Rs₅₂ are each independently of the other hydrogen or C₁-C₄alkyl, or Rs₅₁ and Rs₅₂ together form a C₄-C₆alkylene bridge which may be interrupted by oxygen, NH or by —N(C₁-C₄alkyl)-;

or a compound of formula S-V

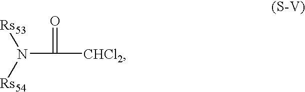

wherein Rs₅₃ and Rs₅₄ are each independently of the other C₁-C₆alkyl or C₂-C₆alkenyl; or

Rs₅₃ and Rs₅₄ together are

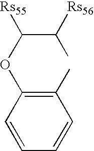

Rs₅₅ and Rs₅₆ are each independently of the other hydrogen or C₁-C₆alkyl; or Rs₅₃ and Rs₅₄ together are

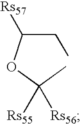

wherein Rs₅₅ and Rs₅₆ are each independently of the other C₁-C₄alkyl, or Rs₅₅ and Rs₅₆ together are —(CH₂)₅—;

Rs₅₇ is hydrogen, C₁-C₄alkyl or

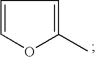

or Rs₅₃ and Rs₅₄ together are

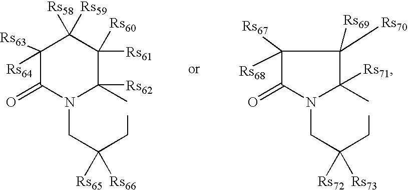

wherein

Rs₅₈, Rs₅₉, Rs₆₀, Rs₆₁, Rs₆₂, Rs₆₃, Rs₆₄, Rs₆₅, Rs₆₆, Rs₆₇, Rs₆₈, Rs₆₉, Rs₇₀, Rs₇₁, Rs₇₂ and Rs₇₃ are each independently of the others hydrogen or C₁-C₄alkyl;

or a compound of formula S-VI

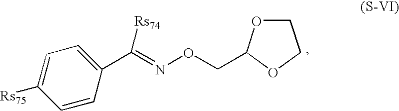

wherein Rs₇₅ is hydrogen or chlorine and Rs₇₄ is cyano or trifluoromethyl;

or a compound of formula S-VII

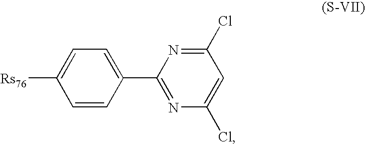

wherein Rs₇₆ is hydrogen or methyl;

or a compound of formula S-VIII

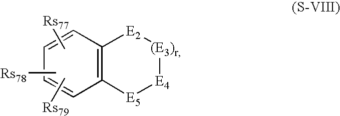

wherein

r is 0 or 1;

Rs₇₇ is hydrogen or C₁-C₄alkyl which may be substituted by C₁-C₄alkoxy, C₁-C₄alkylthio, C₁-C₄alkylsulfinyl, C₁-C₄alkylsulfonyl, C₁-C₄haloalkyl, C₁-C₄haloalkoxy, C₁-C₄haloalkylthio, C₁-C₄haloalkylsulfinyl, C₁-C₄haloalkylsulfonyl, nitro, cyano, —COOH, COO—C₁-C₄alkyl, —NRs₈₀Rs₈₁, —SO₂NRs₈₂Rs₈₃ or by —CONRs₈₄Rs₈₅;

Rs₇₈ is hydrogen, halogen, C₁-C₄alkyl, trifluoromethyl, C₁-C₄alkoxy or C₁-C₄haloalkoxy;

Rs₇₉ is hydrogen, halogen or C₁-C₄alkyl;

Rs₈₀ is hydrogen, C₁-C₄alkyl or C₁-C₄alkylcarbonyl;

Rs₈₁ is hydrogen or C₁-C₄alkyl; or

Rs₈₀ and Rs₈₁ together form a C₄- or C₅-alkylene group;

Rs₈₂, Rs₈₃, Rs₈₄ and Rs₈₅ are each independently of the others hydrogen or C₁-C₄alkyl; or

Rs₈₂ is, together with Rs₈₃, or Rs₈₄ is, together with Rs₈₅, each independently of the other, C₄- or C₅-alkylene, it being possible for a carbon atom to have been replaced by oxygen or by sulfur or for one or two carbon atoms to have been replaced by —NH— or by —N(C₁-C₄alkyl)-;

E₂, E₃, E₄ and E₅ are each independently of the others oxygen, sulfur, C(Rs₈₆)Rs₈₇, carbonyl, —NH—, —N(C₁-C₈alkyl)-, a group

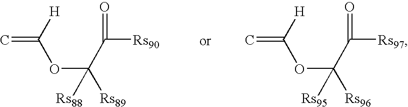

Rs₈₆ and Rs₈₇ are each independently of the other hydrogen or C₁-C₈alkyl; or

Rs₈₆ and Rs₈₇ together are C₂-C₆alkylene;

Rs₈₈ and Rs₈₉ are each independently of the other hydrogen or C₁-C₈alkyl; or

Rs₈₈ and Rs₈₉ together form a C₂-C₆alkylene group;

Rs₉₀ is Rs₉₁—O—, Rs₉₂—S— or —NRs₉₃Rs₉₄;

Rs₉₁ and Rs₉₂ are each independently of the other hydrogen, C₁-C₈alkyl, C₁-C₈haloalkyl, C₁-C₄alkoxy-C₁-C₈alkyl, C₃-C₆alkenyloxy-C₁-C₈alkyl or phenyl-C₁-C₈alkyl, it being possible for the phenyl ring to be substituted by halogen, C₁-C₄alkyl, trifluoromethyl, methoxy, methylthio, methylsulfinyl or by methylsulfonyl, or C₃-C₆alkenyl, C₃-C₆haloalkenyl, phenyl-C₃-C₆alkenyl, C₃-C₆alkynyl, phenyl-C₃-C₆alkynyl, oxetanyl, furyl or tetrahydrofuryl;

Rs₉₃ is hydrogen, C₁-C₈alkyl, phenyl, phenyl-C₁-C₈alkyl, it being possible for the phenyl rings to be substituted by fluorine, chlorine, bromine, nitro, cyano, —OCH₃, C₁-C₄alkyl or by CH₃SO₂—, C₁-C₄alkoxy-C₁-C₈alkyl, C₃-C₆alkenyl or C₃-C₆alkynyl;

Rs₉₄ is hydrogen, C₁-C₈alkyl, C₃-C₆alkenyl or C₃-C₆alkynyl; or

Rs₉₃and Rs₉₄ together are C₄- or C₅-alkylene, it being possible for a carbon atom to have been replaced by oxygen or by sulfur or for one or two carbon atoms to have been replaced by —NH— or by —N(C₁-C₄alkyl)-;

Rs₉₅ and Rs₉₆ are each independently of the other hydrogen or C₁-C₈alkyl; or

Rs₉₅ and Rs₉₆ together form a C₂-C₆alkylene group; and

Rs₉₇ is C₂-C₄alkenyl or C₂-C₄alkynyl; with the provisos that

a) at least one of the ring members E₂, E₃, E₄ and E₅ is carbonyl, and a ring member adjacent to that or those ring member(s) is a group

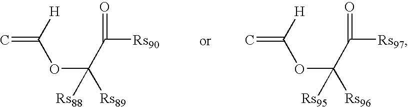

only one such group being present; and

b) two adjacent ring members E₂ and E₃, E₃ and E₄, and E₄ and E₅ cannot simultaneously be oxygen;

or a compound of formula S-IX

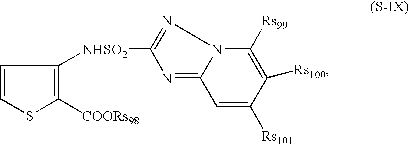

wherein Rs₉₈ is hydrogen, C₁-C₆alkyl, C₃-C₆cycloalkyl, C₃-C₆alkenyl or C₃-C₆alkynyl; and

Rs₉₉, Rs₁₀₀ and Rs₁₀₁ are each independently of the others hydrogen, C₁-C₆alkyl, C₃-C₆-cycloalkyl or C₁-C₆alkoxy, with the proviso that one of the substituents Rs₉₉, Rs₁₀₀ and Rs₁₀₁ is other than hydrogen;

or a compound of formula S-X

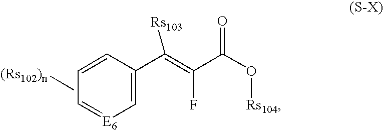

wherein E₆ is nitrogen or methine, and, where E₆ is nitrogen, n is 0, 1, 2 or 3 and, where E₆ is methine, n is 0, 1, 2, 3 or 4, Rs₁₀₂ is halogen, C₁-C₄alkyl, C₁-C₄haloalkyl, C₁-C₄alkoxy, C₁-C₄haloalkoxy, nitro, C₁-C₄alkylthio, C₁-C₄alkylsulfonyl, C₁-C₄alkoxycarbonyl, phenyl or phenoxy, or phenyl or phenoxy each substituted by C₁-C₃alkyl, C₁-C₃haloalkyl, C₁-C₃alkoxy, C₁-C₃haloalkoxy, halogen, cyano or by nitro;

Rs₁₀₃ is hydrogen or C₁-C₄alkyl;

Rs₁₀₄ is hydrogen, C₁-C₄alkyl, C₃-C₆cycloalkyl, C₂-C₆alkenyl, C₂-C₆alkynyl, C₁-C₄haloalkyl, C₂-C₆haloalkenyl, C₂-C₆haloalkynyl, C₁-C₄alkylthio-C₁-C₄alkyl, C₁-C₄alkylsulfonyl-C₁-C₄alkyl, C₁-C₄alkoxy-C₁-C₄alkyl, C₁-C₄alkenyloxy-C₁-C₄alkyl or C₁-C₄alkynyloxy-C₁-C₄alkyl;

or a compound of formula S-XI

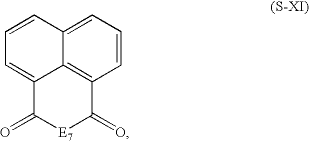

wherein E₇ is oxygen or N—R₁₀₅, and Rs₁₀₅ is a group of formula

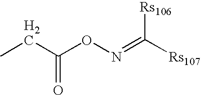

wherein Rs₁₀₆ and Rs₁₀₇ are each independently of the other cyano, hydrogen, C₁-C₄alkyl, C₃-C₆cycloalkyl, C₂-C₆alkenyl, aryl, phenyl or heteroaryl, or phenyl, aryl or heteroaryl each substituted by C₁-C₃alkyl, C₁-C₃haloalkyl, C₁-C₃alkoxy, C₁-C₃haloalkoxy, halogen, cyano or by nitro;

or a compound of formula S-XII

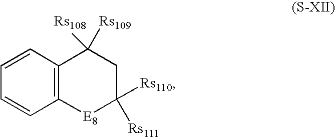

wherein E₈ is oxygen, sulfur, sulfinyl, sulfonyl or methine,

Rs₁₀₈ and Rs₁₀₉ are each independently of the other CH₂COORs₁₁₂ or COORs₁₁₃ or together are a group of formula —(CH₂)C(O)—O—C(O)—(CH₂)—, and Rs₁₁₂ and Rs₁₁₃ are each independently of the other hydrogen, C₁-C₄alkyl, C₂-C₄alkenyl, C₂-C₆alkynyl, C₃-C₆cycloalkyl, C₁-C₄haloalkyl, a metal cation or an ammonium cation; and

Rs₁₁₀ and Rs₁₁₁ are each independently of the other hydrogen, halogen or C₁-C₄alkyl;

or a compound of formula S-XIII

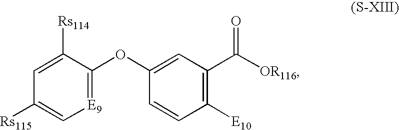

wherein Rs₁₁₄ and Rs₁₁₅ are each independently of the other hydrogen, halogen or C₁-C₄haloalkyl, R₁₁₆ is hydrogen, C₁-C₄alkyl, C₃-C₄alkenyl, C₃-C₄alkynyl, C₁-C₄haloalkyl, C₃-C₆cycloalkyl, a metal cation or an ammonium cation;

E₉ is nitrogen, methine, C—F or C—Cl, and

E₁₀ is a group of formula

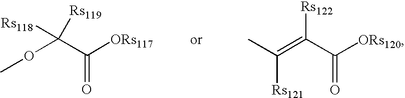

wherein Rs₁₁₈, Rs₁₁₉, Rs₁₂₁ and

Rs₁₂₂ are each independently of the others hydrogen or C₁-C₄alkyl;

Rs₁₁₇ and Rs₁₂₀ are each independently of the other hydrogen, C₁-C₄alkyl, C₃-C₄alkenyl, C₃-C₄alkynyl, C₁-C₄haloalkyl, C₃-C₆cycloalkyl, a metal cation or an ammonium cation;

or a compound of formula S-XIV

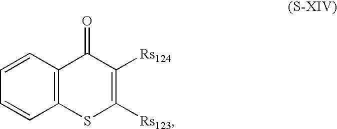

wherein Rs₁₂₃ is hydrogen, cyano, halogen, C₁-C₄alkyl, C₃-C₆cycloalkyl, C₁-C₄alkoxy, C₁-C₄alkoxycarbonyl, C₁-C₄alkylthiocarbonyl, —NH—Rs₁₂₅, —C(O)NH—Rs₁₂₆, aryl or heteroaryl, or aryl or heteroaryl substituted by C₁-C₃alkyl, C₁-C₃haloalkyl, C₁-C₃alkoxy, C₁-C₃haloalkoxy, halogen, cyano or by nitro;

Rs₁₂₄ is hydrogen, cyano, nitro, halogen, C₁-C₄alkyl, C₁-C₄haloalkyl, C₁-C₄alkoxy or C₁-C₄thioalkyl; and

Rs₁₂₅ and Rs₁₂₆ are each independently of the other C₁-C₄alkyl, C₁-C₄haloalkyl, C₃-C₄alkenyl, C₃-C₄alkynyl, C₃-C₄cycloalkyl, C₁-C₄alkylcarbonyl, C₁-C₄alkylsulfonyl, aryl or heteroaryl, or aryl or heteroaryl each substituted by C₁-C₃alkyl, C₁-C₃haloalkyl, C₁-C₃alkoxy, C₁-C₃halo-alkoxy, halogen, cyano or by nitro;

or a compound of formula S-XV

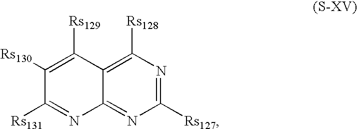

wherein Rs₁₂₇ and Rs₁₂₈ are each independently of the other hydrogen, C₁-C₄alkyl, C₁-C₄-haloalkyl, C₁-C₄alkoxy, mono-C₁-C₈- or di-C₁-C₈-alkylamino, C₃-C₆cycloalkyl, C₁-C₄thioalkyl, phenyl or heteroaryl;

Rs₁₂₉ is hydrogen, C₁-C₄alkyl, C₁-C₄haloalkyl, C₁-C₄alkoxy, mono-C₁-C₈- or di-C₁-C₈-alkylamino, C₃-C₆cycloalkyl, C₁-C₄thioalkyl, phenyl, heteroaryl, OH, NH₂, halogen, di-C₁-C₄-aminoalkyl, C₁-C₄alkylthio, C₁-C₄alkylsulfonyl or C₁-C₄alkoxycarbonyl;

Rs₁₃₀ is hydrogen, C₁-C₄alkyl, C₁-C₄haloalkyl, C₁-C₄alkoxy, mono-C₁-C₈- or di-C₁-C₈-alkylamino, C₃-C₆cycloalkyl, C₁-C₄thioalkyl, phenyl, heteroaryl, cyano, nitro, carboxyl, C₁-C₄-alkoxycarbonyl, di-C₁-C₄aminoalkyl, C₁-C₄alkylthio, C₁-C₄alkylsulfonyl, SO₂—OH, i-C₁-C₄-aminoalkylsulfonyl or C₁-C₄alkoxysulfonyl;

Rs₁₃₁ is hydrogen, C₁-C₄alkyl, C₁-C₄haloalkyl, C₁-C₄alkoxy, mono-C₁-C₈- or di-C₁-C₈-alkylamino, C₃-C₆cycloalkyl, C₁-C₄thioalkyl, phenyl, heteroaryl, OH, NH₂, halogen, di-C₁-C₄-aminoalkyl, pyrrolidin-1-yl, piperidin-1-yl, morpholin-1-yl, C₁-C₄alkylthio, C₁-C₄alkylsulfonyl, C₁-C₄alkoxycarbonyl, phenoxy, naphthoxy, phenylamino, benzoyloxy or phenylsulfonyloxy;

or a compound of formula S-XVI

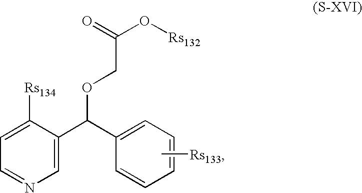

wherein Rs₁₃₂ is hydrogen, C₄alkyl, C₁-C₄haloalkyl, C₂-C₄alkenyl, C₂-C₄alkynyl or C₁-C₄alkoxy-C₁-C₄alkyl;

Rs₁₃₃ is hydrogen, halogen, C₁-C₄alkyl, C₁-C₄haloalkyl or C₁-C₄alkoxy and Rs₁₃₄ is hydrogen, halogen, C₁-C₄alkyl, C₁-C₄haloalkyl or C₁-C₄alkoxy; with the proviso that Rs₁₃₃ and Rs₁₃₄ are not simultaneously hydrogen.

For the composition according to the invention, especially preferred safeners are selected from the group of compounds

of formula S1.1

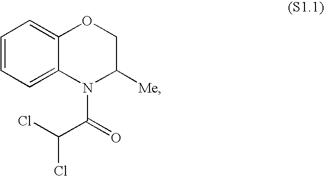

and the compound of formula S1.2

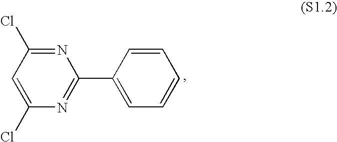

and the compound of formula S1.3

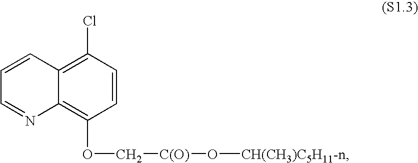

and the compound of formula S1.4

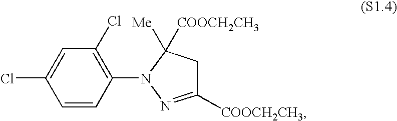

and the compound of formula S1.5

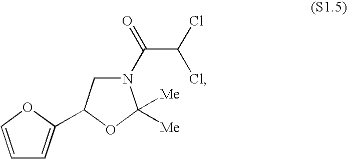

and the compound of formula S1.6

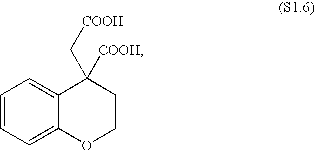

and the compound of formula S1.7

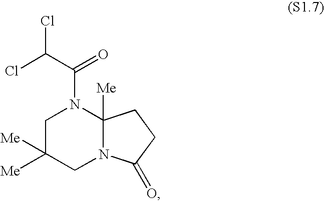

and the compound of formula S1.8

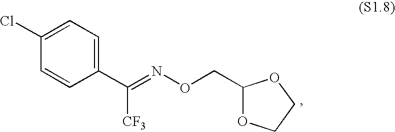

and of formula S1.9

Cl₂CHCON(CH₂CH═CH₂) (S1.9),

and of formula S1.10

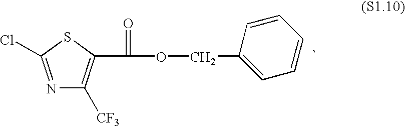

and of formula S1.11

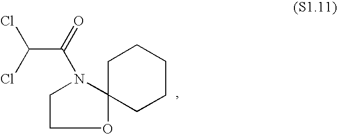

and of formula S1.12

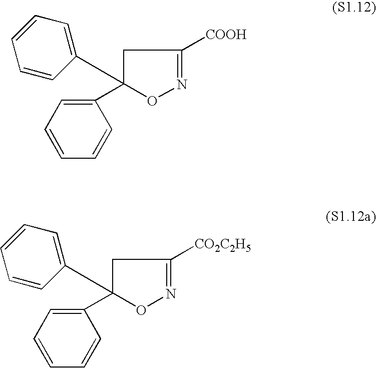

and of formula S1.13

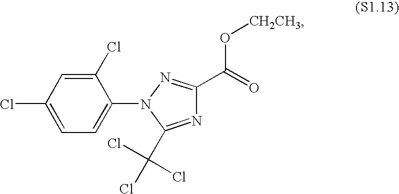

The compounds of formulae S1.1 to S1.13 are known and are described, for example, in The Pesticide Manual, 11th Ed., British Crop Protection Council, 1997 under entry numbers 61 (formula S1.1, benoxacor), 304 (formula S1.2, fenclorim), 154 (formula S1.3, cloquintocet), 462 (formula S1.4, mefenpyr-diethyl), 377 (formula S1.5, furilazole), 363 (formula S1.8, fluxofenim), 213 (formula S1.9, dichlormid) and 350 (formula S1.10, flurazole). The compound of formula S1.11 is known by the name MON 4660 (Monsanto) and is described, for example, in EP-A-0 436 483.

The compound of formula S1.6 (AC 304415) is described, for example, in EP-A-0 613 618, and the compound of formula S1.7 in DE-A-2 948 535. The compounds of formulae S1.12 and S1.12a (isoxadifen) are described in DE-A4 331 448, and the compound of formula S1.13 is described in DE-A-3 525 205.

Especially preferred safeners are the compounds of formulae S1.1, S1.9 and S1.12a. Very especially effective compositions according to the present invention accordingly comprise the following active ingredient combinations:

metolachlor+amicarbazone+benoxacor, metolachlor+foramsulfuron+benoxacor, metolachlor+tritosulfuron+benoxacor and metolachlor+the compound of formula A+benoxacor, metolachlor+amicarbazone+dichlormid, metolachlor+foramsulfuron+dichlormid, metolachlor+tritosulfuron+dichlormid, metolachlor+the compound of formula A+dichlormid, metolachlor+amicarbazone+isoxadifen, metolachlor+foramsulfuron+isoxadifen, metolachlor+tritosulfuron+isoxadifen and metolachlor+the compound of formula A+isoxadifen. Further very suitable compositions comprise, instead of metolachlor, its S-metolachlor enantiomer or a mixture of metolachlor with a relatively high amount of S-metolachlor, the proportion of S-metolachlor in the mixture being from 60 to 95% by weight, especially from 70 to 90% by weight.

The active ingredients used in accordance with the invention may be employed in unmodified form, that is to say as obtained in synthesis. Preferably, however, they are formulated in customary manner, together with the adjuvants conventionally used in formulation technology, such as solvents, solid carriers or surfactants, for example into emulsifiable concentrates, directly sprayable or dilutable solutions, wettable powders, soluble powders, dusts, granules or microcapsules, as described in WO 97/34483, pages 9 to 13. As with the nature of the compositions, the methods of application, such as spraying, atomising, dusting, wetting, scattering or pouring, are chosen in accordance with the intended objectives and the prevailing circumstances. The formulations, i.e. the media, preparations or compositions comprising the mixtures according to the invention and also, as appropriate, one or more solid or liquid formulation adjuvants, are prepared in a manner known per se, e.g. by intimately mixing and/or grinding the active ingredients with the formulation adjuvants, e.g. solvents or solid carriers. In addition, surface-active compounds (surfactants) may also be used in the preparation of the formulations.

Examples of solvents and solid carriers are given, for example, in WO 97/34485, page 6. Depending on the nature of the active ingredients to be formulated, suitable surface-active compounds are non-ionic, cationic and/or anionic surfactants and surfactant mixtures having good emulsifying, dispersing and wetting properties. Examples of suitable anionic, non-ionic and cationic surfactants are listed, for example, in WO 97/34485, pages 7 and 8. Also suitable for the preparation of the herbicidal compositions according to the invention are the surfactants conventionally employed in formulation technology, which are described, inter alia, in “McCutcheon's Detergents and Emulsifiers Annual” MC Publishing Corp., Ridgewood N.J., 1981, Stache, H., “Tensid-Taschenbuch”, Carl Hanser Verlag, Munich/Vienna, 1981 and M. and J. Ash, “Encyclopedia of Surfactants”, Vol I-III, Chemical Publishing Co., New York, 1980-81.

The herbicidal formulations usually contain from 0.1 to 99% by weight, especially from 0.1 to 95% by weight, of active ingredient mixture according to the invention, from 1 to 99.9% by weight of a solid or liquid formulation adjuvant, and from 0 to 25% by weight, especially from 0.1 to 25% by weight, of a surfactant.

Whereas commercial products are usually formulated as concentrates, the end user will normally employ dilute formulations. The compositions may also comprise further ingredients, such as stabilisers, e.g. vegetable oils or epoxidised vegetable oils (epoxidised coconut oil, rapeseed oil or soybean oil), antifoams, e.g. silicone oil, preservatives, viscosity regulators, binders, tackifiers, and also fertilisers or other active ingredients. Preferred formulations have especially the following compositions:

(% =percent by weight)

| | |
|---|---|
| Emulsifiable concentrates: | |
| active ingredient mixture: | 1 to 90%, preferably 5 to 20% |
| surfactant: | 1 to 30%, preferably 10 to 20% |
| liquid carrier: | 5 to 94%, preferably 70 to 85% |
| Dusts: | |
| active ingredient mixture: | 0.1 to 10%, preferably 0.1 to 5% |
| solid carrier: | 99.9 to 90%, preferably 99.9 to 99% |
| Suspension concentrates: | |
| active ingredient mixture: | 5 to 75%, preferably 10 to 50% |
| water: | 94 to 24%, preferably 88 to 30% |
| surfactant: | 1 to 40%, preferably 2 to 30% |
| Wettable powders: | |
| active ingredient mixture: | 0.5 to 90%, preferably 1 to 80% |
| surfactant: | 0.5 to 20%, preferably 1 to 15% |
| solid carrier: | 5 to 95%, preferably 15 to 90% |
| Granules: | |
| active ingredient mixture: | 0.1 to 30%, preferably 0.1 to 15% |
| solid carrier: | 99.5 to 70%, preferably 97 to 85% |

The following Examples illustrate the invention further, but do not limit the invention.

| F1. Emulsifiable concentrates | a) | b) | c) | d) |
|---|---|---|---|---|
| active ingredient mixture | 5% | 10% | 25% | 50% |
| calcium dodecylbenzenesulfonate | 6% | 8% | 6% | 8% |
| castor oil polyglycol ether | 4% | — | 4% | 4% |
| (36 mol of ethylene oxide) | | | | |
| octylphenol polyglycol ether | — | 4% | — | 2% |
| (7-8 mol of ethylene oxide) | | | | |
| cyclohexanone | — | — | 10% | 20% |
| arom. hydrocarbon mixture | 85% | 78% | 55% | 16% |
| C₉-C₁₂ | | | | |

Emulsions of any desired concentration can be obtained from such concentrates by dilution with water.

| | a) | b) | c) | d) |
|---|---|---|---|---|
| F2. Solutions | | | | |
| active ingredient mixture | 5% | 10% | 50% | 90% |
| 1-methoxy-3-(3-methoxy- | — | 20% | 20% | — |
| propoxy)-propane | | | | |
| polyethylene glycol MW 400 | 20% | 10% | — | — |
| N-methyl-2-pyrrolidone | — | — | 30% | 10% |
| arom. hydrocarbon mixture | 75% | 60% | — | — |
| C₉-C₁₂ | | | | |

The solutions are suitable for use in the form of microdrops.

| | | | | |
|---|---|---|---|---|
| F3. Wettable powders | | | | |
| active ingredient mixture | 5% | 25% | 50% | 80% |
| sodium lignosulfonate | 4% | — | 3% | — |
| sodium lauryl sulfate | 2% | 3% | — | 4% |
| sodium diisobutylnaphthalene- | — | 6% | 5% | 6% |
| sulfonate | | | | |
| octylphenol polyglycol ether | — | 1% | 2% | — |
| (7-8 mol of ethylene oxide) | | | | |
| highly dispersed silicic acid | 1% | 3% | 5% | 10% |
| kaolin | 88% | 62% | 35% | — |

The active ingredient is mixed thoroughly with the adjuvants and the mixture is thoroughly ground in a suitable mill, affording wettable powders which can be diluted with water to give suspensions of any desired concentration.

| F4. Coated granules | a) | b) | c) |
|---|---|---|---|
| active ingredient mixture | 0.1% | 5% | 15% |
| highly dispersed silicic acid | 0.9% | 2% | 2% |
| inorganic carrier | 99.0% | 93% | 83% |
| (diameter 0.1-1 mm) | | | |
| e.g. CaCO₃ or SiO₂ | | | |

The active ingredient is dissolved in methylene chloride and applied to the carrier by spraying, and the solvent is then evaporated off in vacuo.

| F5. Coated granules | a) | b) | c) |
|---|---|---|---|
| active ingredient mixture | 0.1% | 5% | 15% |
| polyethylene glycol MW 200 | 1.0% | 2% | 3% |
| highly dispersed silicic acid | 0.9% | 1% | 2% |
| inorganic carrier | 98.0% | 92% | 80% |
| (diameter 0.1-1 mm) | | | |
| e.g. CaCO₃ or SiO₂ | | | |

The finely ground active ingredient is uniformly applied, in a mixer, to the carrier moistened with polyethylene glycol. Non-dusty coated granules are obtained in this manner.

| F6. Extruder granules | a) | b) | c) | d) |
|---|---|---|---|---|
| active ingredient mixture | 0.1% | 3% | 5% | 15% |
| sodium lignosulfonate | 1.5% | 2% | 3% | 4% |
| carboxymethylcellulose | 1.4% | 2% | 2% | 2% |
| kaolin | 97.0% | 93% | 90% | 79% |

The active ingredient is mixed and ground with the adjuvants, and the mixture is moistened with water. The mixture is extruded and then dried in a stream of air.

| F7. Dusts | a) | b) | c) |
|---|---|---|---|
| active ingredient mixture | 0.1% | 1% | 5% |
| talcum | 39.9% | 49% | 35% |
| kaolin | 60.0% | 50% | 60% |

Ready-to-use dusts are obtained by mixing the active ingredient with the carriers and grinding the mixture in a suitable mill.

| F8. Suspension concentrates | a) | b) | c) | d) |
|---|---|---|---|---|
| active ingredient mixture | 3% | 10% | 25% | 50% |
| ethylene glycol | 5% | 5% | 5% | 5% |
| nonylphenol polyglycol ether | — | 1% | 2% | — |
| (15 mol of ethylene oxide) | | | | |
| sodium lignosulfonate | 3% | 3% | 4% | 5% |
| carboxymethylcellulose | 1% | 1% | 1% | 1% |
| 37% aqueous formaldehyde | 0.2% | 0.2% | 0.2% | 0.2% |
| solution | | | | |
| silicone oil emulsion | 0.8% | 0.8% | 0.8% | 0.8% |
| water | 87% | 79% | 62% | 38% |

The finely ground active ingredient is intimately mixed with the adjuvants, giving a suspension concentrate from which suspensions of any desired concentration can be obtained by dilution with water.

It is often more practical for the active ingredients of the mixtures according to the invention to be formulated separately and to be brought together in the desired mixing ratio in the applicator in the form of a “tank mixture” in water shortly before application.

### BIOLOGICAL EXAMPLES

### Example B1

### Pre-Emergence Test

The test plants are sown in pots under greenhouse conditions. A standard soil is used as cultivation substrate. At a pre-emergence stage, the herbicides, both on their own and in admixture, are applied to the surface of the soil. The rates of application depend on the optimum concentrations ascertained under field conditions or greenhouse conditions. The tests are evaluated after from 2 to 4 weeks (100% action=plant is completely dead; 0% action=no phytotoxic action). The mixtures used in this test show good results.

### Example B2

### Post-Emergence Test

The test plants are grown in pots under greenhouse conditions until a post-application stage. A standard soil is used as cultivation substrate. At a post-emergence stage, the herbicides, both on their own and in admixture, are applied to the test plants. The rates of application depend on the optimum concentrations ascertained under field conditions or greenhouse conditions. The tests are evaluated after from 2 to 4 weeks (100% action=plant is completely dead; 0% action=no phytotoxic action). The mixtures used in this test show good results.

1. A herbicidal synergistic composition which, in addition to comprising customary inert formulation adjuvants, comprises as active ingredient a mixture of
a) metolachlor and/or the S enantiomer thereof and
b) a synergistically effective amount of at least one compound from the group amicarbazone, foramsulfuron, tritosulfuron and the compound of formula A

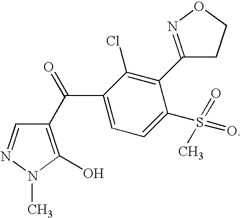

2. A herbicidal composition according to claim 1, which comprises a safener as additional component c).

3. A method of controlling undesired plant growth in crops of useful plants, which comprises allowing a herbicidally effective amount of a composition according to claim 1 to act on the crop plant or the locus thereof.

4. A method according to claim 3, wherein the crop plant is maize.
